(19) United States
(12) Patent Application Publication
(10) Pub. No.: US 2005/0160656 A1
(43) Pub. Date: Jul. 28, 2005

(54) Self-spreading trawls having a high aspect ratio mouth opening

(76) Inventors: Sheriff Adham Safwat, Rolling Bay, WA (US); Valentin Gavrilovich Perevoshchikov, Kaliningrad (RU)

Correspondence Address: Donald E Schreiber;Donald E Schreiber A Professional Corporation, Post Office Box 2926, Kings Beach, CA, 96143-2926, US

(21) Appl. No.: 10/508,685

(22) PCT Filed: Mar. 22, 2003
(86) PCT No.: PCT/US03/10114

Related U.S. Application Data
(60) Provisional application No. 60/367,134, filed on Mar. 22, 2002.
(60) Provisional application No. 60/366,834, filed on Mar. 23, 2002.

(51) Int. Cl. A01K 73/04; A01K 73/02; D02G 3/22

(52) U.S. Cl. 43/9.95; 43/9.1

(57) ABSTRACT

An improved self-spreading trawl (13) includes first panels (56T, 56B) which when towed through a body of water (12) separate on opposite sides of the trawl's central axis (62). Portions of panels (56T, 56B) form portions of the trawl's mouth (26). The trawl (13) also includes second panels (56P, 56S) which separate on opposite sides of the central axis (62) from the sides occupied by the panels (56T, 56B). Portions of panels (56P, 56S) form portions of the trawl's mouth (26). Regions of panels (56P, 56S) generate more outwardly directed lift than corresponding regions of the panels (56T, 56B). When towed through the body of water (12): a) a distance separating the panels (56P, 56S) exceeds; b) a distance separating the panels (56T, 56B). Also a braided product strand which includes at least 3 plaits (76, 102), at least one (76) of which is larger than the others (102), advantageously exhibits less drag and vibration.

### TECHNICAL FIELD

The present invention relates generally to the technical field of trawls used for fishing and, more particularly, to an improved construction for self-spreading mid-water trawls.

### BACKGROUND ART

In the field of pelagic and semipelagic fisheries a well recognized problem exists that a targeted species is frequently intermingled with one or more untargeted species. Thus, catching a targeted species with currently available pelagic fish nets, such as pelagic trawl nets that are also known as mid-water trawls, inadvertently results in undesired catching of non-targeted species, frequently referred to as “bycatch.

In the North Pacific Pollock fishery, for example, the targeted species is often densely intermingled with other species. However, during many fishing conditions a comparatively thin strata of water is often substantially free of the non-targeted species, while simultaneously possessing an acceptable density of the targeted species. Directly above this comparatively thin strata that holds an acceptable density of the targeted species and is substantially free of the non-targeted species, there tends to exist a much thicker strata of water that is densely occupied both by the non-targeted and the targeted species. Usually there are neither targeted species nor non-targeted species below the comparatively thin strata that holds an acceptable density of the targeted species and is substantially free of the non-targeted species. Consequently, fishing vessels, that can be penalized for catching non-targeted species, want to fish with maximum efficacy in the narrow strata of water that is substantially free of the non-targeted species thereby reducing and, if possible, avoiding bycatch.

Conventional mid-water trawls, i.e. non self-spreading trawls which are in general cone-shaped and are rather long from front to rear, are substantially less effective if their design or use exhibits a wide horizontal mouth opening and a short vertical mouth opening, e.g. an opening that is 75-200% or more wider than tall. One reason such conventional trawls are less effective if they have such a high aspect ratio mouth opening is that the relatively short vertical opening does not transfer vertically oriented opening forces well from the mouth of the trawl far back to the rear sections of the trawl.

For the preceding reason, conventional mid-water trawls which are intended to exhibit a horizontal mouth opening which is at least 2 times greater than the trawl's vertical opening (i.e. 100% greater) are designed with side panels that are intended to be fished with far lower angles of mesh cell opening in an attempt to reduce the compressive force generated by constriction, i.e. loss of width, of diamond trawl meshes under load. The greater the mesh cell opening angle to achieve a certain mesh cell width, the greater potential for compressive forces due to constriction of loaded mesh cells. Such compressive force occurring in the trawl's side panels tend to collapse the trawl's vertical opening in the aft section of the trawl.

In an attempt to address the problem caused by loaded side panel mesh cells having substantial opening angles collapsing a trawl's vertical opening, contemporary conventional trawls designed to exhibit a high aspect ratio have side panels in which the number of similar sized mesh cells in any particular cross-sectional cut across the trawl have far smaller angles of opening compared to mesh cells in the trawl's top or bottom panels. To obtain these smaller angles of mesh cell opening in side panels, the ratio of the width of the top and bottom panels to the width of a side panel in any particular cross-sectional cut across the trawl of a trawl tends not to exceed 1.25:1 (one point two five to one), and more commonly 1:1 (one to one). Nevertheless, trawls with such closely similar panel widths are then fished with a ratio of horizontal to vertical mouth opening that exceeds 1.5:1 (one point five to one), and often as great as 2.5:1 (two and a half to one), and even more. The contemporary thinking tends to be that low angles of mesh cell opening in the side panels reduces compressive forces that constrain the trawls vertical opening, and maximize deflected water impact force which aids in expanding the trawl in the horizontal plane with less compressive force in the vertical plane thereby preventing the trawl's collapse.

In addition to the above mentioned difficulties, such contemporary conventional trawls designs are relatively expensive to manufacture because they require a comparatively large number of mesh cells and material for narrower side panels. Furthermore, since contemporary conventional trawls lack any force which tends to actively maintain vertical opening, the trawls vertical opening tends to be lost under real fishing conditions which frequently collapses the trawl's aft end. Furthermore, such trawls also tend to produce unwarranted bycatch, for example of marine mammals.

Published Patent Cooperation Treaty (“PCT”) International Patent Applications WO 97/13407, WO 98/46070 and WO 99/39572 (“the published PCT patent applications”) describe various structures and construction techniques for assembling mid-water trawls in which mesh bars forming the trawl's mesh cells, when towed through a body of water, actively produce outwardly directed lift, i.e. lift which has a component directed away from the trawl's central axis. As disclosed in the published PCT patent applications, threads, such as twines, cords, braided cords, cables, ropes or straps, may be advantageously twisted, during assembly of mesh bars which form a trawl's mesh cells, into a loose, corkscrew-shaped pitch thereby establishing helical grooves that are deeper and broader than the depressions in conventional tightly or loosely twisted three-strand ropes or cables. When a properly configured trawl having mesh bars which possess such helical grooves is towed through a body of water, cambered sections established by the helical grooves produce outwardly directed lift. The published PCT patent applications are hereby incorporated by reference as though fully set forth here.

A belief generally exists that self-spreading trawls assembled in accordance with the published PCT patent applications cannot provide a high aspect trawl mouth opening, i.e. a self-spreading trawl in which the top and bottom panels are wider in calculated overall width than the side panels when considering the mesh cell size and the planned percentage opening of the mesh cells. It has been believed that the spreading force of doors included in a trawl system is such that any additional horizontal outwardly directed lift would collapse the already more narrow vertical opening of a self-spreading trawl. Moreover, use of lift generating mesh bars in assembling mesh cells of “wide body” trawls, i.e. trawls in which at any particular cross-sectional cut across the trawl the top and bottom panels are substantially wider than the height of the trawls side panels for equal mesh cell opening angle, has been unanimously deemed a failure by trawl manufacturers.

The published PCT applications disclose many different ways in which threads, such as twines, cords, braided cords, cables or ropes, may be twisted, during assembly of mesh bars which form a trawl's mesh cells, into a loose, corkscrew-shaped pitch with helical grooves. However, of the many different ways in which threads may be twisted into a loose, corkscrew-shaped pitch with helical grooves, for economic reasons only a few of the many different techniques disclosed in the published PCT applications have been used thus far in commercially manufactured mid-water trawls.

One technique used commercially for forming mesh bars which have a loose, corkscrew-shaped pitch with helical grooves is that depicted in FIGS. 4-9d and 15 of published PCT patent application WO 97/13407. The technique depicted in those FIGs., in which loops at ends of the mesh bars are formed with spliced eyes, advantageously preserves significantly more of the strength of threads forming the mesh bars than joining ends of the mesh bars using a knot. Moreover, mesh bars having spliced eyes formed on the end thereof exhibit lower drag than mesh bars joined by a knot. However, mesh bars formed by a twisted pair of threads in the way illustrated in FIGS. 4-9d and 15 are more fragile than if all the material making up the pair of twisted strands were formed into a single, unitary mesh bar.

Another technique used commercially for forming mesh bars which have a loose, corkscrew-shaped pitch with helical grooves is that depicted in FIG. 29 of published PCT patent application WO 98/46070. The mesh bar structure depicted in that FIG. proves to be more rugged than a mesh bar made from a pair of twisted strands because all of the material is incorporated into a single, unitary mesh bar. Unfortunately, the use of spliced eyes for mesh bars having the structure depicted in FIG. 29 is commercially impractical. Therefore, for economic reasons ends of mesh bars made with the structure depicted in FIG. 29 are joined together using strength reducing knots.

### Definitions

BRIDLES relates to lines that intersect the frontropes and attach to the tow lines. For a particular port or starboard tow line, a pair of bridles extend from a common connection point therewith, back to the frontropes.

CELL means a trawl construction unit used in fishing nets or the like and includes both a mesh cell relating to enclosable sides of the mesh of the trawl or net itself, as well as to upper bridle and frontropes used in towing the trawl or net through a water column to gather marine life.

CELL BAR means both the sides of a mesh cell and the elements that make up the upper bridle, frontropes and tow lines.

CODEND or BRAILER BAG is a portion of a trawl positioned at the trailing end thereof and comprises a closed sac-like terminus in which the gathered marine life including fish are trapped.

CATCH PER UNIT EFFORT (“CPUE”) is the total tonnage of fish caught with a trawl divided by the total fuel a vessel consumes while fishing with the trawl.

FRAME is a portion of the larger sized meshes of a net or trawl upon which is overlaid a netting of finer construction.

FRONTROPE(S) is a term that includes all lines located at perimeter edge of the mouth of the trawl, net or the like, such as headrope, footrope (or bottomrope) and breast lines. The frontropes have a number of connections relative to each other and to the bridle lines.

INTERNAL BRAID describes the method of formation of a particular product strand.

INTERNAL LAY OR TWIST is the direction in which synthetic or natural fibers comprising each product strand are wound when such strand is viewed axially and in a receding direction.

LAY is the direction in which the strands or the straps making up mesh bars twist when viewed axially and in a receding direction.

MESH is one of the openings between threads, ropes or cords of a net.

MESH BARS means the sides of a mesh cell, and does not include knots or equivalent couplers unless otherwise specified.

MESH CELL means the sides of a mesh and includes at least three sides and associated knots or equivalent couplers oriented in space. A quadratic mesh cell has four sides with four knots or couplers, and is usually arranged to form a parallelogram (including rectangular and square), with diamond-shaped mesh (trawl mesh) being preferred. A triangular mesh cell has three sides and three knots or couplers. A hexagonal mesh cell has six sides and six knots or couplers.

NET is a meshed arrangement of threads that have been woven or knotted or otherwise coupled together usually at regular intervals or at intervals that vary usually uniformly along the length of the trawl.

PANEL is one of the sections of a trawl and may be made to fit generally within and about frame ropes, including riblines, that are offset from the central axis of the trawl.

PITCH is the amount of advance viewed axially:
i. in one turn of one product strand twisted about another product strand or strands; or
ii. the twist of a strap along its axis of symmetry; or
iii. in one turn of one product strand that is braided together with other product strands.

For product strands, pitch values are determined with respect to the diameter of the next-to-largest product strand. For straps, pitch values are determined with respect to the width of the strap.

PRODUCT STRAND includes the synthetic or natural fibers or filaments used to form the construction unit of the invention which is preferably, but not necessarily, the product of a conventional manufacturing process. Product strands are preferably made of synthetic fibers or filaments which are preferably, but not necessarily, the product of a conventional manufacturing process, usually made of nylon, polyethylene, polyester, or the like. Such strands can be twisted, plaited, braided or laid parallel to form a sub-unit for further twisting or other use within a mesh bar or a cell bar in accordance with the invention.

RIGHT- AND/OR LEFT-HANDEDNESS IN A RECEDING DIRECTION along a cell bar involves establishing a central axis for the trawl, net or the like to which the mesh cell associated with the cell bar belongs. Then a normalized imaginary giant stick figure, that is depicted in FIGs. of the published PCT patent applications, is positioned so his feet intersect the central axis, are rotatable about the central axis, his body penetrates through the cell bar, and his back is positioned perpendicular to and first intersects the water flow vector for the moving trawl, net or the like. The right- and/or left-handedness of the cell bar is then determined using the location of either his right or his left arm irrespective of the fact that the position of the cell bar is offset from the central axis.

STRAP is a flexible element of synthetic or natural fibers that forms a mesh bar, the strap having a cross-section that is generally rectangular or can be quasi-rectangular with rounded short sides and elongated long sides with or without camber. In operation, the strap acts as a hydrofoil, preferably twisted along its longitudinal axis, wherein the short sides form interchanging leading and trailing edges.

THREADS are composed of synthetic or natural fibers. Firstly, for the present invention a thread can comprise two strands twisted along the longitudinal axis of symmetry in a loose fashion with a pitch in a range of 3d-70d, where d is:
1. for a pair of twisted strands forming a mesh bar, the diameter of the smaller strand of the pair; or
2. for mesh bars that include more than a pair of twisted strands or strands of differing diameters, the diameter of the next-to-largest diameter twisted strand.

Or secondly, for the present invention a thread can comprise a extruded, woven, braided, or plaited strap that is twisted along its longitudinal axis of symmetry in a loose fashion with a pitch in a range of 3d-70d, where d is the width of the strap.

TRAWL is a large net generally in the shape of a truncated cone trailed through a water column or dragged along a sea bottom to gather marine life including fish.

TRAWL SYSTEM is a term that includes the trawl, net or the like in association with the tow lines therefor as well as the bridles lines.

### DISCLOSURE OF INVENTION

An object of the present invention is to provide a trawl that reduces bycatch.

Another object of the present invention is to provide a self-spreading trawl which when towed through a body of water has a mouth which exhibits a high aspect ratio.

Another object of the present invention is to provide a self-spreading trawl which when towed through a body of water has a mouth which exhibits a high aspect ratio while concurrently maintaining an open back-end.

Another object of the present invention is to provide a self-spreading trawl which when towed through a body of water has a mouth which exhibits a high aspect ratio while concurrently requiring a lesser amount of weights about a footrope of the trawl.

Another object of the present invention is to provide a self-spreading trawl in which the top panel has a width that is at least twenty percent (20%) greater, and preferably at least forty percent (40%) or more greater, than the width of the trawl's side panels.

Yet another object of the present invention is to provide self-spreading trawls made with unitary mesh bars which are more rugged, and the ends of which may be joined together using strength retaining spliced eyes.

Briefly the present invention in one embodiment is an improved self-spreading trawl which during field operations in a body of water becomes disposed about a central axis. The trawl includes a mouth that is disposed:
a) between a vessel that tows the trawl and a back-end of the trawl that is distal from the towing vessel; and
b) transversely to and about the central axis of the trawl.

An improved self-spreading trawl in accordance with the present invention also includes a first pair of panels which when the trawl is towed through a body of water become separated on opposite sides of the trawl's central axis. Portions of the first pair of panels form portions of the mouth of the trawl. The improved self-spreading trawl also includes a second pair of panels which when the trawl is towed through a body of water become separated on opposite sides of the central axis of the trawl which differ from the sides of the central axis on which the first pair of panels becomes disposed. Portions of the second pair of panels form portions of the mouth of the trawl which differ from the portions of the mouth of the trawl formed by portions of the first pair of panels.

Regions of the second pair of panels in the improved self-spreading trawl are configured to generate more outwardly directed lift that is directed away from the central axis of the trawl than corresponding regions of the first pair of panels. Thus, when the trawl is towed through a body of water:
a) a distance which separates those portions of the second pair of panels which form portions of the mouth of the trawl exceeds;
b) a distance which separates those portions of the first pair of panels which form portions of the mouth of the trawl.

Another aspect of the present invention is a braided product strand which when towed through a body of water exhibits less drag and vibration. The braided product strand includes at least 3 (three) plaits, at least one of which has a larger cross-sectional area than other plaits included in the product strand. The larger plait(s) has a cross-sectional area that is/are at least 0.9 (nine tenths) times larger than a combined cross-sectional area of all other plaits also included in the product strand.

An advantage exhibited by trawls which practice the present invention is that they may be fabricated with a ratio of width of the top and bottom panels relative to width of the side panels of 1.5:1 (one and a half to one) and may even equal or exceed a ratio of 2.0:1 (two to one). Since when being towed through a body of water mesh cells included in side panels generally exhibit considerably lower angles of mesh opening compared to the angle of mesh openings of mesh cells in the top and bottom panels, the aspect ratio of the mouth opening can considerably exceed the width ratios of the top and bottom panels relative to the side panels. Trawls having such width ratios of top to side panels when configured in accordance with the present invention exhibit surprisingly better vertical opening particularly in the mid-section and back-end together with wide horizontal opening. For such trawls when towed by similarly powered vessels the horizontal mouth opening for a particular vertical mouth opening significantly exceeds that of known trawls. Ratios of horizontal mouth opening compared to vertical mouth opening greater than 3:1 (three to one), 4:1 (four to one), 5:1 (five to one), 6:1 (six to one), 7:1 (seven to one), and even greater than 10:1 (ten to one) have been modeled for a wide range of bollard pull values, including relatively low bollard pull values as are exhibited by comparatively low horsepower vessels. Consequently, assembling trawls in accordance with the present invention permits custom design of trawl opening and fishing parameters to reduce fuel consumption, reduce bycatch, and better operations compared with present conventional trawl constructions and methods. The present invention is most useful if bettering fishing gear's CPUE and reducing bycatch are primary objectives.

These and other features, objects and advantages will be understood or apparent to those of ordinary skill in the art from the following detailed description of the preferred embodiment as illustrated in the various drawing figures.

### BRIEF DESCRIPTION OF DRAWINGS

FIG. 1 is an elevational view of a trawl system depicting a mid-water trawl being towed by a vessel;

FIG. 2 is a detail plan view of the trawl of FIG. 1 viewed from above;

FIG. 3 is a fragmentary enlargement of a mesh cell, that may be included in the trawl depicted in FIGS. 1 and 2, having mesh bars made from product strands;

FIGS. 4A through 4C are plan views illustrating various different configurations for corkscrew-shaped product strands;

FIG. 5 is another fragmentary enlargement of a mesh cell, that may be included in the trawl depicted in FIGS. 1 and 2, having mesh bars made from straps;

FIG. 6 is a plan view of a type of strap mesh bar in which one product strand, included among overbraided product strands, spirals around another product strand;

FIG. 7 are a plan views, respectively, of a top panel, side panel and bottom panel for a forward section of a trawl in accordance with the present invention;

FIG. 8 are a plan views, respectively, of a top panel, side panel and bottom panel for a forward section of a trawl in accordance with the present invention that is adapted for deeper trawling;

FIG. 9 are a plan views, respectively, of a top-bottom panel and a side panel for a forward section of a trawl in accordance with the present invention; and

FIGS. 10A and 10B are respectively plan views of alternative mesh bar constructions each of which is adapted for being joined to other mesh bars using spliced eyes.

### BEST MODE FOR CARRYING OUT THE INVENTION

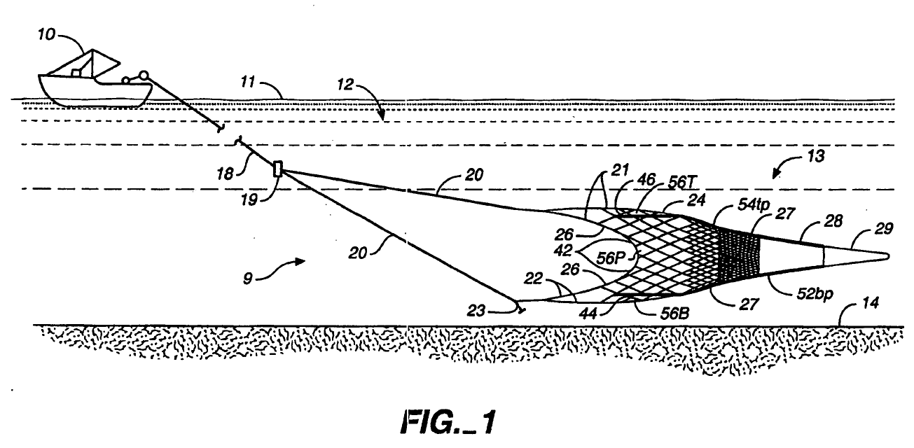

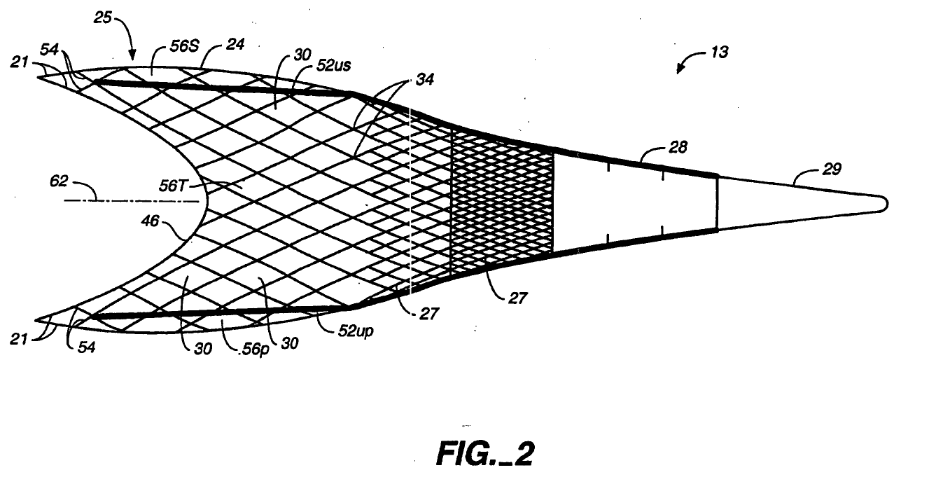

Referring to FIG. 1, a towing vessel 10 at a surface 11 of a body of water 12, tows a mid-water trawl 13 that is part of a trawl system 9. When being towed, the trawl 13 is located between the surface 11 and an ocean bottom 14. The trawl 13 can be connected to the vessel 10 in many ways, such as by main tow lines 18 connected through doors 19, towing bridles 20 and mini-bridles 21, 22. A group of weights 23 is attached to mini-bridle 22. The trawl 13 also includes frontropes that include breastlines 42, a footrope 44, and a headrope 46, illustrated more clearly in FIG. 2. The shape, pattern and configuration of the trawl 13 varies in many different ways as is well known in the art.

As depicted in FIG. 1, the trawl 13 has a forward section 24 that includes forward projecting wings 25, best illustrated in FIG. 2, for better herding at a mouth 26 of the trawl 13. The footrope 44 and the headrope 46 respectively span across the mouth of the trawl 13 between the wings 25. The trawl 13 also includes a mid-section 27 one side of which abuts the forward section 24, a back-end 28 one side of which abuts a side of the mid-section 27 that is distal from the forward section 24, and a codend 29 one side of which abuts a side of the back-end 28 that is distal from the mid-section 27.

As illustrated in FIG. 2, the trawl 13 includes series of mesh cells 30 preferably of quadratic cross-section. The size of mesh cells 30 is measured by a distance between a pair of knots or equivalent couplers 34 that are located at diagonally opposite corners of the mesh cell 30, and when that pair of knots or couplers 34 are separated as far as possible from each other. Different sections of the trawl 13, and even different regions within a section, use different size mesh cells 30, which generally form a repeating pattern within that section or region of a section.

The trawl 13 also preferably includes both an upper starboard ribline 52us and an upper port ribline 52up, both depicted in FIG. 2. The upper starboard ribline 52us and the upper port ribline 52up extend from the front of the wings 25 at least to a juncture between the back-end 28 and the codend 29. In some instances, the riblines 52 may even extend to an end of the codend 29 distal from the back-end 28. FIG. 1 depicts both the upper port ribline 52up and a lower port ribline 521p. The trawl 13 also includes a lower starboard ribline 521s which is not depicted either in FIG. 1 or in FIG. 2. The mesh cells 30 immediately adjacent to each of the riblines 52 are preferably lashed securely thereto.

Usually, product strands forming the riblines 52 are 1.0 to 1.5 inches in diameter. The riblines 52 for the forward section 24 of the trawl 13 are preferably made from fibers which exhibit high elasticity. Conversely, the riblines 52 for the back-end 28 are preferably made from a material which exhibits low elasticity. For example, riblines 52 in the aft end of the trawl 13 may be made from a material which elongates less four percent (4%) when the trawl 13 is towed through the body of water 12.

In the plan view of the trawl 13 depicted in FIG. 2, the forwardmost ends of the riblines 52 are connected by ribline supports 54 to the mini-bridles 21. Each of the riblines 52 couples the force of drag originating at the mesh cells 30 of the forward section 24, the mid-section 27 and the back-end 28 of the trawl 13 via the ribline supports 54 and the mini-bridles 21 to the towing bridles 20. By coupling drag that originates at the mesh cells 30 to the towing bridles 20, the riblines 52 improve the shape of the trawl 13, particularly in the back-end 28, which would be subject to distortion if a significant portion of that drag were coupled to the towing bridles 20 under heavy catch loads through the mesh cells 30 rather than through the riblines 52.

As depicted in FIG. 2, a top panel 56T spans across the trawl 13 between the upper starboard ribline 52us and the upper port ribline 52up. The headrope 46 forms a leading edge of the top panel 56T at the mouth 26 of the trawl 13. A starboard side-panel 56S and a port side-panel 56P extend outward respectively from the upper starboard ribline 52us and the upper port ribline 52up away from the top panel 56T. As depicted in FIG. 1, the port side-panel 56P spans between the upper port ribline 52up and the lower port ribline 521p. The trawl 13 also includes a bottom panel 56B, illustrated in FIG. 1, which spans between the lower port ribline 521p and the lower starboard ribline 521s, that is not illustrated either in FIG. 1 or in FIG. 2. Similarly, though not shown either in FIG. 1 or in FIG. 2, the starboard side-panel 56S spans between the upper starboard ribline 52us and the lower starboard ribline 521s. Similar to the headrope 46, the footrope 44 forms a leading edge of the bottom panel 56B at the mouth 26 of the trawl 13.

When the trawl 13 is towed through the body of water 12, all of the panels 56 are offset from a central axis 62 of the trawl 13. Consequently, configured in this way the top panel 56T and the bottom panel 56B are separated on opposite sides of the central axis 62, and the side-panels 56S, 56P are also separated on opposite sides of the central axis 62 which differ from the sides on which the top panel 56T and bottom panel 56B are disposed. Furthermore, a forward portion of each of the panels 56 of the forward section 24 form different portions of the mouth 26 of the trawl 13.

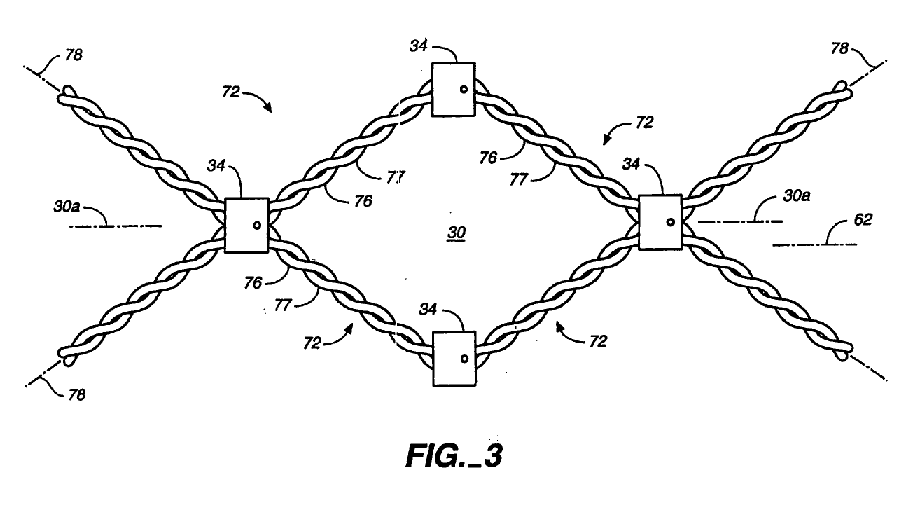

As depicted in FIG. 3, each of the mesh cells 30 has a longitudinal axis of symmetry 30a. In the embodiment depicted in FIG. 3, the mesh cell 30 is formed by a set of mesh bars 72 each of which includes product strands 76, 77. As explained in greater detail below, the product strands 76, 77 may be twisted about a common axis of symmetry 78 in either one or the other of two lay directions: clockwise or counterclockwise as viewed axially along common axis of symmetry 78 and in a receding direction established upstream of the trawl 13. Various different ways for forming the cork-screw shape of the mesh bars 72 is described in the published PCT patent applications.

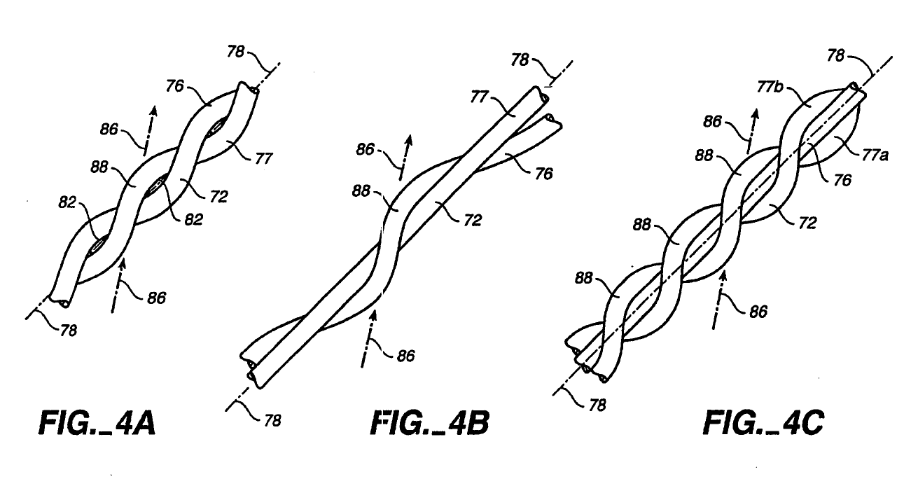

FIGS. 4A through 4C depict various different configurations for mesh bars 72 made from product strands 76, 77 that have the loose, corkscrew-shaped pitch. In the illustration of FIG. 4A, the product strands 76, 77 twist equally about the common axis of symmetry 78. FIG. 4B depicts a configuration for the product strands 76, 77 in which the product strand 76 spirals around the product strand 77 which is aligned coaxially with the common axis of symmetry 78. FIG. 4C depicts a configuration for product strands 76, 77 in which the pair of product strands 77 spiral around the product strand 76 which is aligned coaxially with the common axis of symmetry 78. The loose, corkscrew-shaped pitch of the product strands 76, 77 establishes deep grooves 82 in the mesh bars 72. In FIGS. 4A through 4C, an arrowed line indicates a possible direction of a water flow vector 86 past cambered sections 88 provided by each of the mesh bars 72 depicted in those FIGs.

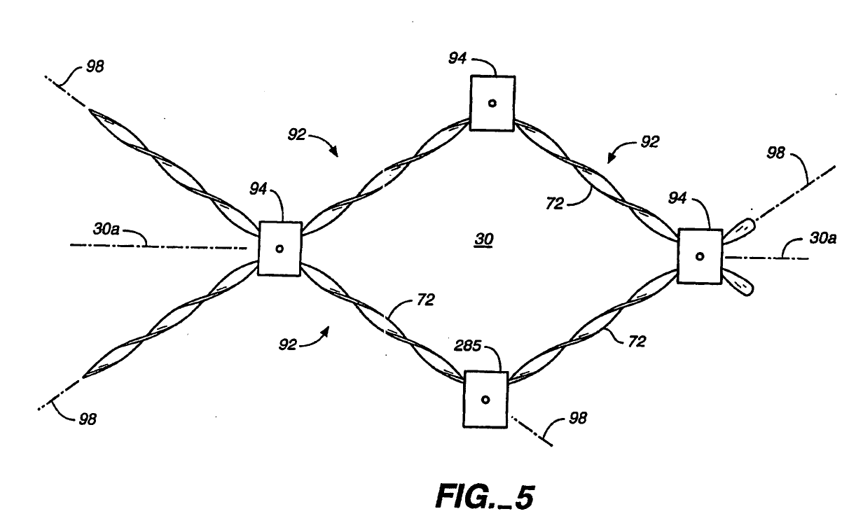

FIG. 5 illustrates another type of cork-screw shaped mesh bars 72 that is described in the published PCT patent applications. In the illustration of FIG. 5, the mesh bars 72 of each mesh cell 30 are respectively formed by straps 92 arranged in a X-pattern using a series of mechanical connections 84 to maintain such orientation. Each strap 92 is twisted about a axis of symmetry 88 in either one or the other of two lay directions: clockwise or counterclockwise as viewed axially along axis of symmetry 88 and in a receding direction established upstream of the trawl 13. Such twisting of the straps 92, either left-handed or right-handed as required, occurs about the axis of symmetry 88 as disclosed in the published-PCT patent applications.

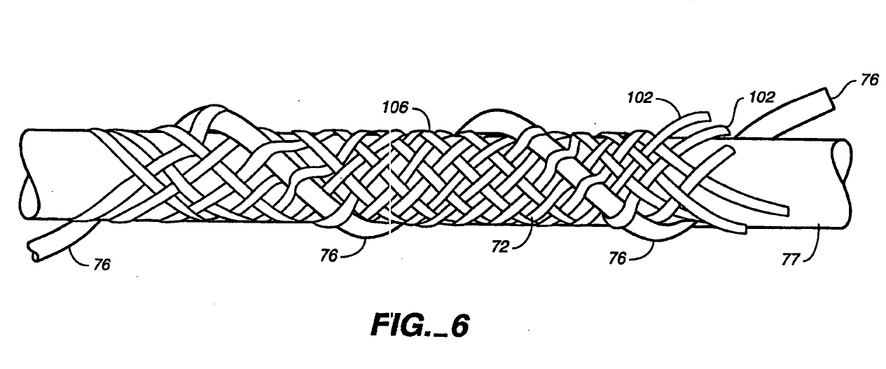

One characteristic of the mesh bars 72 depicted in FIGS. 4A-4C is that field operations may apply a force that urges the product strand 76 to slide with respect to the product strand 77. FIG. 6 depicts a configuration for a type of strap 92 which prevents the product strand 76 from sliding with respect to the product strand 77. In the configuration for the strap 92 depicted in FIG. 6, the larger diameter product strand 76 is included among smaller diameter product strands 102 that form a conventional braided sheath 106 that encircles the product strand 77.

To increase the lift generating capability of the mesh bar 72 depicted in FIG. 6 while reducing its drag, it is preferred that product strand 76 be made from a hydrophobic material, especially a material more hydrophobic than nylon, while also being made from a material that is less elastic than nylon. Furthermore, the actual construction of the product strand 76 and not just the raw material is important. The product strand 76 should be constructed as solid and non-porous as possible. For example, the product strand 76 should have a dense construction, such as a “compact twine” if it is a braided construction, or a “firm/hard lay” construction if it is a twisted twine. Densely laid twisted twines, where the direction of twisting of the primary sub-strands of the product strand 76 corresponds to the lay direction of the mesh bar 72, also exhibit superior lift generation and drag reduction characteristics. For many applications, it is also preferable if the product strand 76 have an elongate cross-sectional shape in the finished mesh bar 72, with the long dimension of the elongate product strand 76 more parallel to a tangential line of the cross section of product strand 77 than perpendicular to the tangential line. Preferably the product strand 77 is made from a material that is more elastic than the material used for product strand 76.

For the mesh bar 72 depicted in FIG. 6, it is important that the overbraiding product strands 102 tightly bind both product strands 76, 77, to prevent water absorption, and to exhibit low drag. Similarly, the product strands 102 are preferably made from a less elastic and less hydrophilic material than the material forming product strand 77, particularly a material that is less hydrophilic than nylon. Also, the product strand 76 included in the mesh bar 72 should initially be as smooth as practicable, and should wear and/or abrade as smooth as possible.

Compact twine braided constructions for the helixing product strand 76, i.e. where a core of parallel or twisted filaments (including slightly twisted filaments) is encased by a braided jacket, has surprisingly and unexpectedly been shown to increase lift and to reduce drag, particularly when the filaments are a made from a hydrophobic material including high tenacity and conventional polyethylene. Such compact braided twine constructions demonstrate, surprisingly, more than a 50% increase in lift relative to non-compact braided twine constructions of the same filaments.

Further, in reference to the mesh bar 72 depicted in FIG. 6, it has been discovered, surprisingly and unanticipated, that the diameter (or width) of the product strand 76 relative to the combined diameter (or width) of product strand 77 and the sheath created by product strands 102 (i.e. the combined diameter of overbraided product strand 77 with overbraiding product strands 102) should be at least forty-five hundredths to one (0.45:1). Preferably, a diameter (or width) for the product strand 76 relative to the combined diameter (or width) of product strand 77 and the sheath created by product strands 102 that is greater than one-half to one (0.5:1), such as 0.6:1 (six tenths to one) or 0.65:1 (sixty five hundredths to one), with 0.55:1 (fifty five hundredths to one) to 0.75:1 (seventy five hundredths to one) and even significantly larger up to or exceeding one to one (1:1), generally provides greater lift particularly for the larger ratios.

To further increase lift, additional product strands, not illustrated in any of the FIGs., of the same or smaller diameter as the product strand 76, may be placed directly adjacent to and parallel to product strand 76. For example, two, three, or more additional product strands 76 helixing about product strand 77 increase hydrofoil characteristics such as useful camber, and provide a mesh bar 72 which provides more lift. A pair of larger and smaller product strands 76, with the mesh bars 72 oriented so that the larger product strand 76 mainly meets the water flow first, also proves to be advantageous.

Since the shape of the trawl 13 varies along the central axis 62 from almost rectangularly or elongated and quasi-rectangularly shaped at the wings 25 to a shape that more nearly approaches a frustum of a cone throughout the forward section 24, mid-section 27 and back-end 28, the longitudinal axis of symmetry 30a of individual mesh cells 30 have varying orientations with respect to the central axis 62 of the trawl 13. Thus, with respect to the central axis 62 of the trawl 13, the longitudinal axes of symmetry 30a of mesh cell 30 may be parallel, non-parallel and non-intersecting, and/or non-parallel and intersecting. However, note that longitudinal axes of symmetry 30a of the mesh cells 30 are always offset from the central axis 62 of the trawl 263.

As depicted in FIGS. 1 and 2, the forward section 24, including the wings 25, is usually assembled using larger size mesh cells 30 than those used respectively for the mid-section 27, the back-end 28, or the codend 29 of the trawl 13. Consequently, the length of mesh bars 72 varies along the length of the trawl 13. For example, the mesh bars 72 in the forward section 24 have a length of at least 10 ft (304.8 cm). Alternatively, the mesh bars 72 in the mid-section 27 have length between 10 ft. (304.8 cm) and 0.75 ft (22.86 cm). The mesh bars 72 of the back-end 28 have a length less than 0.75 ft (22.86 cm).

Furthermore, as described in greater detail below, in accordance with the present invention the mesh cells 30 included in the side-panels 56S, 56P of the trawl 13, which may or may not be separated from the top and/or bottom panel by riblines 52, are preferably assembled from mesh bars 72 or straps 92 having either or several:
i. similar constructions and diameters in comparison with mesh bars 72 in the top panel 56T, i.e. not more than twenty-two percent (22%) smaller in diameter than mesh bars 72 in the top panel 56T;
ii. larger values of lift constant at designed angles of incidence to the water flow vector 86 in comparison with values of lift constant at designed angles of incidence to the water flow vector 86 for mesh bars 72 in the top panel 56T and/or bottom panel 56B;
iii. larger diameter product strands 76, 77 or straps 92 in comparison with mesh bars 72 having a similar construction that are included in the mesh cells 30 of the top panel 56T and/or bottom panel 56B;
iv. a construction that differs from the mesh bars 72 or straps 92 that are included in the mesh cells 30 of the top panel 56T and/or bottom panel 56B; and/or
v. extremely low coefficients of drag when towed through the body of water 12 that do not exceed eight hundredths (0.08), and preferably do not exceed five and one-half hundredths (0.055) at designed angles of incidence to the water flow vector 86.

Any of the preceding differences between mesh bars 72 or straps 92 of the side-panels 56S, 56P are selected to generate more outwardly directed lift for mesh bars 72 of the side-panels 56S, 56P than similarly directed lift generated by mesh bars 72 or straps 92 of the mesh cells 30 of the top panel 56T and/or bottom panel 56B. Consequently, for areas of the side-panels 56S, 56P having similarly sized mesh cells 30, the side-panels 56S, 56P preferably generate more outwardly directed lift per unit area than the top panel 56T or bottom panel 56B.

The various alternative constructions described above are particularly advantageous when the designed horizontal distance across the trawl 13 in the wings 25 and in the forward section 24 exceeds the designed height thereat. Advantageously the designed horizontal distance across the trawl 13 in the wings 25 and in the forward section 24 exceeds the designed height thereat by a ratio of at least one and fourteen-hundredths to one (1.14:1), by a ratio of one and two-tenths to one (1.2:1), and preferably by a ratio of one and seven-tenths to one (1.7:1) or greater. That is, when the designed maximum width of the top panel 56T and the bottom panel 56B compared to the maximum designed width of the side-panels 56S, 56P equals or exceeds one and fourteen-hundredths to one (1.14:1) or one and two-tenths to one (1.2:1). For such designs, the intended percentage of mesh opening of mesh cells 30 in the panels 56 is preferably less than the intended percentage of mesh opening in mesh cells 30 that are located in corresponding regions of the top panel 56T and/or bottom panel 56B. Generally, it is desirable that mesh cells 30 attached to any of the breastlines 42, the footrope 44 or the headrope 46 open at least twenty-five percent (25%), with mesh cells 30 attached to the footrope 44 or the headrope 46 opening thirty percent (30%).

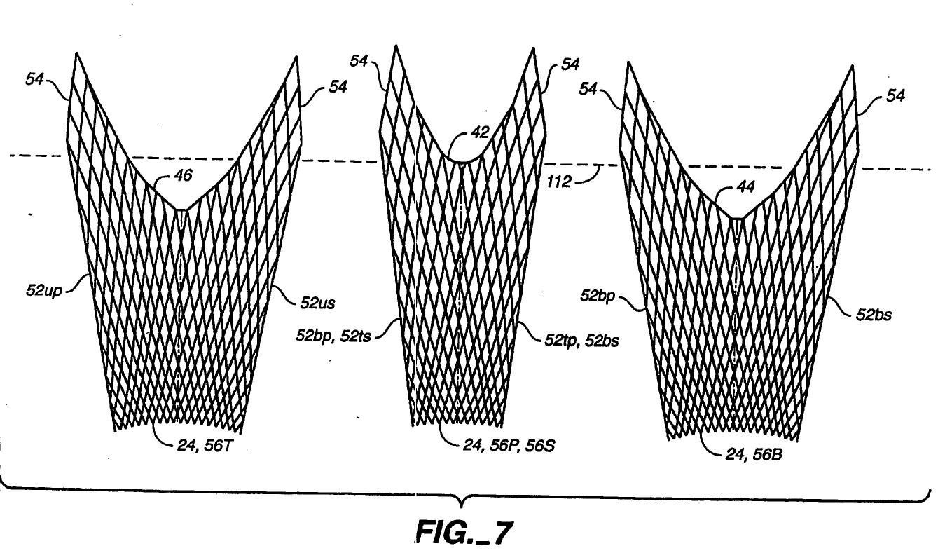

FIG. 7 depicts panels 56t, 56S, 56P, 56B for a preferred embodiment of the present invention, i.e. for a trawl 13 in which self-spreading mesh cells 30 in the side-panels 56S, 56P generate more outwardly directed lift than self-spreading mesh cells 30 in the top panel 56T and/or the bottom panel 56B. Though not clearly visible in FIGS. 1 and 2 but readily apparent in FIG. 7, in accordance with the present invention the side-panels 56S, 56P of the trawl 13 are narrower between the respective upper riblines 52up and 52us and lower riblines 521p and 521s than the top panel 56T of the trawl 13, depicted in FIG. 2, between the upper port ribline 52up and the upper starboard ribline 52us. The embodiment of the panels 56 depicted in FIG. 7 is widely applicable to a range of width ratios of the side-panels 56S, 56P relative to the top panel 56T or the bottom panel 56B. Surprisingly, shockingly, and contrary to conventional opinion of those skilled in the art, the embodiment depicted in FIG. 7 provides both for greater horizontal opening of the mouth 26 of the trawl 13, as desired, with no loss of the desired vertical opening.

In accordance with the present invention the mesh cells 30 in the side-panels 56S, 56P are preferably assembled using mesh bars 72 that generate more lift than mesh bars 72 of the top panel 56T and/or the bottom panel 56B when the ratio of the horizontal opening of the mouth 26 to its vertical opening is to equal or exceeds 2:1, (two to one), and applies as well when the ratio is 2.5:1 (two and one-half to one), 3:1 (three to one), and even 10:1 (ten to one), or greater. However, the greater the desired horizontal opening of the mouth 26 relative to the vertical opening, the more important it becomes to assemble mesh cells 30 of the side-panels 56S, 56P with mesh bars 72 that correspondingly produce more outwardly directed lift than the mesh bars 72 used in assembling the mesh cells 30 of the top panel 56T and/or the bottom panel 56B. Since mesh bars 72 in the mesh cells 30 of the side-panels 56S, 56P generally intersect the water flow vector 86 at a lower angle of attack than mesh bars 72 in the top panel 56T and the bottom panel 56B, the cambered sections 88 of mesh bars 72 in the side-panels 56S, 56P are selected to provide a better lift constant (lift coefficient divided by drag coefficient) at this lower angle of attack.

It will be readily apparent to those skilled in the art that, depending upon design goals for a trawl 13, a wide range of different sizes of mesh bars 72 or, alternatively, different lift generating mesh bars 72 may be used in mesh cells 30 of the side-panels 56S, 56P versus mesh bars 72 used in mesh cells 30 of the top panel 56T and the bottom panel 56B. Thus, a wide range of different diameters and/or combinations of self-spreading mesh bars 72 and sizes of mesh cells 30 in the side-panels 56S, 56P relative to the top panel 56T and/or the bottom panel 56B are intended to be within the scope of the present invention. For example, differences of diameters and/or lift generation exhibited by mesh bars 72 may vary to from 10% to 700%, or greater, in side-panels 56S, 56P verses the top panel 56T and/or the bottom panel 56B. Furthermore, those skilled in the art will also understand that mesh bars 72 which generate different amounts of outwardly directed lift may be used at specific locations within a particular panel 56t, 56P, 56S and/or 56B. For example, it may be desirable to use mesh bars 72 which generate more outwardly directed lift in the wings 25 of the side-panels 56S, 56P while progressively reducing the lift generating characteristic of mesh bars 72 in the side-panels 56S, 56P toward the rear of the trawl 13. Thus in the rear of the forward section 24, for example where mesh cell sizes eight (8) or four (4) meters or less, there may exist no difference in the size and/or lift generating characteristics of the mesh bars 72 forming mesh cells 30 in any of the panels 56. Consequently, when a trawl 13 in accordance with the present invention is towed through the body of water 12 the mid-section 27 and the back-end 28 tend to adopt a more tubular cross-sectional shape than the mouth 26 which tends to adopt a rectangular or elongated oval cross sectional shape.

Furthermore, trawls 13 in accordance with the present invention having a horizontal opening of the mouth 26 which exceeds 2.5 times the vertical opening, that are intended for use in catching pelagic species, may also include riblines 52 that change orientation relative to the mesh cells 30 so that toward the aft end of the trawl 13 the number of mesh cells 30 and the length of the mesh bars 72 in the respective panels 56 differ less than near the mouth 26 of the trawl 13. In accordance with the present invention, toward the aft end of the trawl 13 there may exist no difference in the number of mesh cells 30 or the length of mesh bars 72 across any of the panels 56 that respectively span between the four pairs of riblines 52. For such a trawl 13, the side-panels 56s, 56P taper far less from the front to the back of the trawl 13 than the taper of the top panel 56T and/or the bottom panel 56B. Thus a ratio between the number of mesh cells 30 across the various panels 56 toward the aft end of the trawl 13 may be less than 2:1 (two to one), and may even become 1:1 (one to one).

For one particular trawl 13 constructed in accordance with the present invention when towed by a comparatively low powered vessel 10 and while concurrently maintaining desired vertical dimensions in the aft end of the trawl 13, the horizontal opening of the mouth 26 exceeded seventy (70) fathoms while the vertical opening was twenty (20) fathoms, a ratio of 7:2 (seven to two). Horizontal openings exceeding 10:1 (ten to one) have been modeled without loss of other trawl performance characteristics.

Presently designs for trawls 13 which exhibit an opening at the mouth 26 of a trawl 13 such as 7:2 (seven to two) while retaining other performance characteristics such as large vertical opening in the back-end 28 are unknown, and are therefor available for the first time through use of the present invention. For such trawls 13, at corresponding locations along the length of the trawl 13 and for similarly sized mesh cells 30, lift generating mesh bars 72 of the side-panels 56S, 56P exhibit at least one and one-half times more outwardly directed lift per meter than that generated by mesh bars 72 used in the top panel 56T and/or bottom panel 56B. Preferably, the mesh bars 72 used in assembling similarly sized mesh cells 30 of the side-panels 56S, 56P generate two (2) to eight (8) times more outwardly directed lift per meter than that generated by mesh bars 72 used in the top panel 56T and/or bottom panel 56B. This difference in outwardly directed lift per unit length of mesh bars 72 between the side-panels 56S, 56P and the top panel 56T and bottom panel 56B applies readily to large mesh portions of the trawl 13 such as mesh cells 30 that are eight (8) meters or more in overall length, and preferably for mesh cells 30 that are sixteen (16) meters or more in overall length.

As described above, one method for obtaining the greater lift per unit length of self-spreading mesh bars 72 in the side-panels 56S, 56P than in the top panel 556T of bottom panel 56B is by using larger diameter product strands 76, 77 for the mesh bars 72 in the side-panels 56S, 56P compared with the product strands 76, 77 used in the top panel 56T or bottom panel 56B. Another method described above achieves a high aspect ratio mouth opening using mesh bars 72 having similar diameters in the top panel 56T and side-panels 56S, 56P if, when towed through the body of water 12, the mesh bars 72 in the side-panels 56S, 56P provide greater lift constants (lift coefficient divided by drag coefficient) at designed angles of incidence to the water flow vector 86 in comparison with lift constants of mesh bars 72 in the top panel 56T. Yet another method is using different constructions for the self-spreading mesh bars 72. For example, constructions such as or similar to that shown in FIG. 6 may be used in the side-panels 56S, 56P, while constructions such as or similar to that shown in FIG. 4A may be used in the top panel 56T and bottom panel 56B. For another example, self-spreading constructions such as or similar to that shown in FIG. 4B (including where the product strand 77 has a larger diameter than the product strand 76) may be used in the side-panels 56S, 56P, while constructions such as or similar to that shown in FIG. 4A may be used in the top panel 56T and bottom panel 56B. In such a cases, in at least the top panel 56T and the bottom panel 56B the mesh bars 72 are preferably connected to each other using spliced eyes to maximize strength and minimize required diameters, drag, and material of the mesh bars 72. Any other method for connecting mesh bars 72 that maintains 90-100% of the product strands 76, 77 unknotted strength may also be used for connecting them.

Another method for increasing the amount of outwardly directed lift produced by the side-panels 56S, 56P in comparison with lift produced by the top panel 56T and bottom panel 56B, which also opposes trends in the industry, is concentrating more self-spreading mesh cells 30 in the side-panels 56S, 56P in comparison with the mesh cells 30 in the top panel 56T and bottom panel 56B, while either:
i. maintaining the same size and construction for the cambered sections 88 of the mesh bars 72 in the mesh cells 30; or
ii. otherwise configuring the mesh bars 72 of the panels 56T, 56P, 56S and 56B to provide the same amount of lift per unit length.

Consequently, due to smaller size mesh cells 30 in the side-panels 56S, 56P and larger size mesh cells 30 in the top panel 56T and bottom panel 56B at corresponding locations along the length of the trawl 13 there exists more length of self-spreading mesh bars 72 in the side-panels 56S, 56P than in the top panel 56T and the bottom panel 56B. The greater length of self-spreading mesh bars 72 in the side-panels 56S, 56P generates more outwardly directed lift than that generated by the mesh bars 72 in the top panel 56T and bottom panel 56B. Contrary to popular belief, vertical opening at the mouth 26 of trawls 13 built in this way do not collapse, and, in fact, showed bettered vertical opening in the aft portions of the trawl 13 for a particular vertical opening at the mouth 26. For example, for a balanced design the size of mesh cells 30 of the top panel 56T and the bottom panel 56B may be forty five (45) meters at a particular location along the length of the trawl 13 while those in the same location in the side-panels 56S, 56P may be twenty-two and one-half (22.5) meters in length, i.e. a two to one (2:1) size relationship.

### Deep Trawling Embodiment

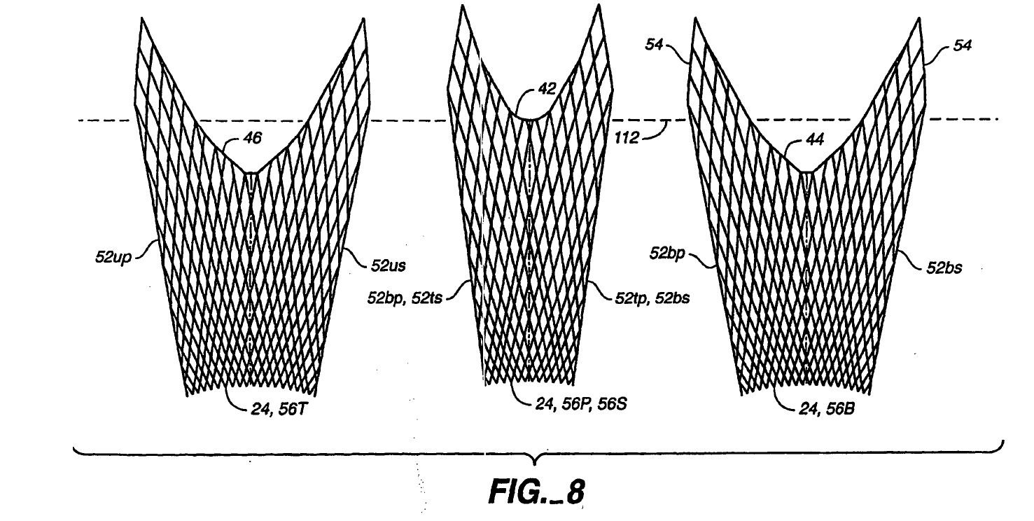

The preferred embodiments described above may be advantageously adapted for trawling deeper in the body of water 12, e.g. deeper than ninety (90) to one-hundred fifty (150) fathoms, when configured as illustrated in FIG. 8. In the alternative embodiment of the invention depicted in FIG. 8:
i. the bottom panel 56B and side-panels 56S, 56P may be assembled using the same size self-spreading mesh bars 72; and/or
ii. the bottom panel 56B is assembled using mesh bars 72 which generate more outwardly directed force than the mesh bars 72 of the top panel 56T.

Configured in this way, when the trawl 13 is towed through the body of water 12 the outwardly directed lift generated by the bottom panel 56B exceeds the outwardly directed lift generated by the top panel 56T. Thus, the greater amount of outwardly directed lift generated by the bottom panel 56B tends to pull the trawl deeper into the body of water 12 with a lesser amount of weights 23. The use of a lesser amount of weight on the trawl 13 permits placing more weight on the doors 19 and/or using heavier doors 19 which increases stability of the doors 19 particularly when being towed through a deep body of water 12 with lengthy main tow lines 18 extending between the vessel 10 and the doors 19. The use of a lesser amount of weights 23 also increases the efficacy of the trawl 13, reduces impact between the trawl 13 and the ocean bottom 14, and also reduces fuel consumption, concurrent pollution and environmental degradation.

### Shallow Trawling Embodiment

If a targeted species occupies a thin strata of the body of water 12 near the surface 11, the preferred embodiment described above may be advantageously adapted for trawling shallow depths, e.g. less than thirty (30) fathoms deep. In configuring the trawl 13 for trawling in shallow depths:
1. the bottom panel 56B and side-panels 56S, 56P may be assembled using the same size self-spreading mesh bars 72; and/or
2. the top panel 56T is assembled using mesh bars 72 which generate more outwardly directed lift than the mesh bars 72 of the bottom panel 56B.

Configured in this way, when the trawl 13 is towed through the body of water 12 the outwardly directed lift generated by the top panel 56T exceeds the outwardly directed lift generated by the bottom panel 56B. A trawl 13 constructed in this way tows nearer the surface 11 without adding floats to the trawl 13, and thereby increases the efficacy of the trawl 13, and also reduces fuel consumption, concurrent pollution and environmental degradation.

### Spread Zone Embodiment

As shown in FIGS. 7, 8 and 9, the side-panels 56S, 56P of the trawls 13 built in accordance with the present invention include a mesh area that extends forward (i.e. away from the back-end 28 and nearer the vessel 10) further than corresponding mesh areas in the top panel 56T and/or bottom panel 56B. That is, the designed center of the breastlines 42, or an equivalent of the designed center of the breastlines 42, preferably projects at least one (1) full mesh length ahead of the designed center of the of the footrope 44 and/or the headrope 46. In FIGS. 7, 8 and 9, a dashed line 112 indicates the location in the side-panels 56S, 56P which has mesh cells 30 spanning completely across the side-panels 56S, 56P between the upper riblines 52up and 52us and the lower riblines 521p and 521s. The dashed line 112 is ahead of, i.e. nearer the vessel 10 than, the location in the top panel 56T and the bottom panel 56B which has mesh cells 30 spanning completely between the port riblines 52up and 521p and the starboard riblines 52us and 521s. That is, when disposed in the body of water 12 the location in the side-panels 56S, 56P at which mesh cells 30 first span completely across the side-panels 56S, 56P between the upper riblines 52up and 52us is nearer the vessel 10 than the location in the top panel 56T and the bottom panel 56B at which mesh cells 30 span completely between the port riblines 52up and 521p and the starboard riblines 52us and 521s. For purposes of this patent application, the area of the side-panels 56S, 56P in front of the dashed line 112 are referred to as the “Spread Zone”. In the illustrations of FIGS. 7 and 8 the Spread Zone begins approximately one (1) full mesh size in front of the corresponding region of the top panel 56T and the bottom panel 56B.

Spreading forces generated by the side-panels 56S, 56P in the Spread Zone relative to spreading forces generated by the top panel 56T or bottom panel 56B in front of the dashed line 112 are significantly greater for a particular amount of drag. Thus, the spreading forces generated by the side-panels 56S, 56P in the Spread Zone assist the doors 19 in opening the mouth 26 of the trawl 13 horizontally which may permit:
i. configuring the doors 19 to produce less drag; or
ii. using smaller and lower drag doors 19.

The spreading force generated in the Spread Zone substantially betters horizontal opening of the trawl 13.

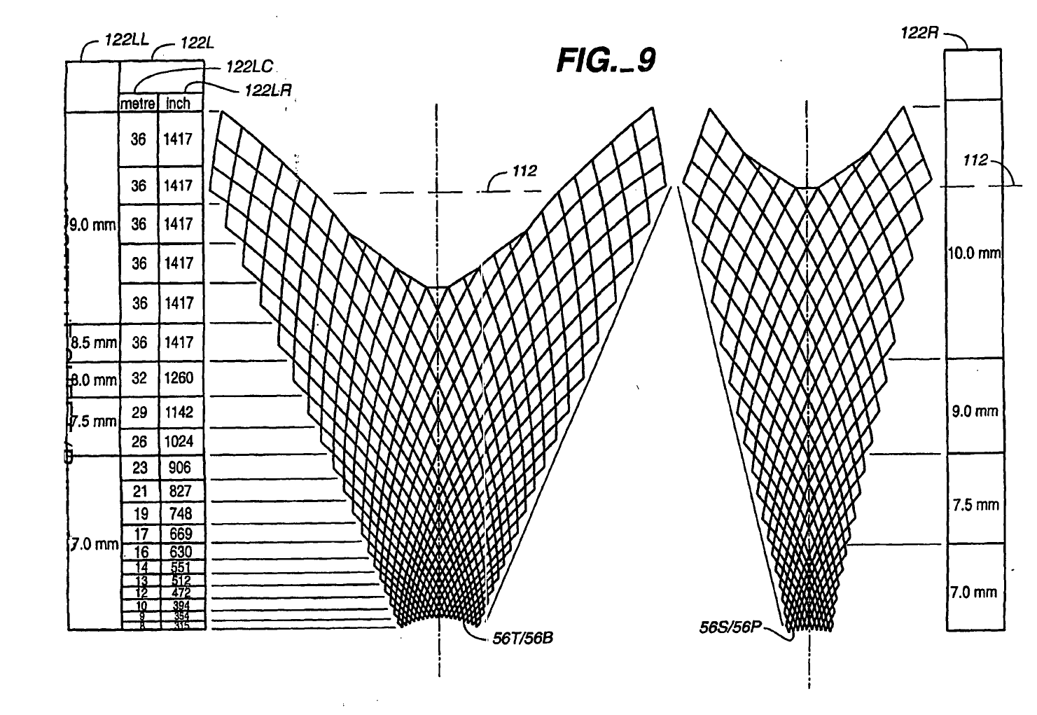

FIG. 9 depicts a top panel 56T/bottom panel 56B and a side-panels 56S, 56P for a forward section 24 of a trawl 13 in accordance with the present invention. Two tables 122L and 122R, respectively located to the left and right of the top panel 56T/bottom panel 56B and side-panels 56S, 56P, list numerical values for mesh bars 72 at various locations in the forward section 24. A left-hand column 122LL in the table 122L list diameters for the product strands 76, 77 used for mesh bars 72 in the top panel 56T/bottom panel 56B. A center and right-hand column 122LC, 122LR in the table 122L lengths of mesh bars 72 in the top panel 56T/bottom panel 56B and side-panels 56S, 56P. The table 122R list diameters for the product strands 76, 77 used for mesh bars 72 in the side-panels 56S, 56P. The construction of the mesh bars 72 appearing in the tables 122L and 122R may be suitable the mesh bar 72 constructions depicted in FIGS. 4A-4C, or FIG. 6.

In FIG. 9 the Spread Zone of the side-panels 56S, 56P begins approximately three (3) full mesh cells 30 in front of the corresponding region of the top panel 56T and the bottom panel 56B. This extended Spread Zone is especially advantageous for opening the trawl 13 horizontally because:
i. the side-panels 56S, 56P in the Spread Zone have to oppose relatively less horizontally oriented constricting forces from the top panel 56T and the bottom panel 56B in this region; and
ii. when towed through the body of water 12 mesh cells 30 in the side-panels 56S, 56P usually have far lower angles of mesh opening than in the top panel 56T and bottom panel 56B, thus permitting the side-panels 56S, 56P to expand outward horizontally thereby substantially increasing horizontal opening at the mouth 26 of the trawl 13.

For the second embodiment of the present invention depicted in FIGS. 7 and 9, it is also useful to design the trawl 13 of the present invention to have relatively low tension in the side-panels 56S, 56P in comparison with, for example, the top panel 56T when the trawl 13 is towed through the body of water 12. That is, the side-panels 56S, 56P are preferentially designed to carry a lesser load in comparison with the top panel 56T. Thus, when the trawl 13 is towed through the body of water 12 the side-panels 56S, 56P are less tense than the top panel 56T which facilitates their horizontal expansion. This lesser tension in the side-panels 56S, 56P is particularly important when the ratio of the top panel 56T to the side-panels 56S, 56P is 1.8:1 (one and eight tenths to one) or more. The lesser tension in the side-panels 56S, 56P also reduces vertical collapsing forces, generated by loading of the mesh cells 30 in the side-panels 56S, 56P.

### Weights 21

For the trawl 13 in accordance with the present invention, relatively few or none of the permanent weights 23 are positioned along the center portion of the footrope 44, i.e. in the middle, or entire center third of the footrope 44 or even as much as the center eighty percent (80%), or more, thereof. With few or none of the permanent weights 23 located at the center of the footrope 44, progressively greater weight is disposed along the footrope 44 so the weight gradually increases, or increases in steps, from the center of the footrope 44 outward to the ends of the footrope 44 that are located at the wings 25. Configured in this way, the largest amount of the weights 23 occurs along that portion of the footrope 44 immediately adjacent to the wings 25. In addition to this permanent footrope weight, the trawl system 9 may also include readily changeable weights 23 that are located at the wings 25.

It is important that particular weight distributions for trawls 13 of the present invention, such as trawls 13 having panels 56 of the type depicted in FIGS. 7 and 8, establish maximum horizontal mouth opening and other opening dimensions. Arranging the permanent weights 23 in the way described above substantially improves horizontal opening of the mouth 26 for trawls 13 of the present invention. Such weight distributions on the footrope 44, though contrary to what is generally employed by those skilled in the art, has been shown to significantly increase horizontal opening of the mouth 26, with no loss of desired vertical opening thereof.

In some instances, a “hanging chain footrope” is suitable for inclusion in the weights 23 in which the footrope 44 is towed near the ocean bottom 14, particularly for reducing damage to the ocean bottom 14 and drag. In a “hanging chain footrope” embodiment, it is helpful if sections of chain incorporated into the hanging chain footrope 44 are longer than the synthetic or natural fiber rope also included in the footrope 44. If sections of chain incorporated into the hanging chain footrope 44 are longer than the rope included therein, the rope may stretch, including creep, without placing any undesirable tension on the chain.

### Radial Mesh Pattern

For larger mesh cells 30 in the forward section 24 and mid-section 27 of the trawl 13, e.g. mesh cells 30 which equal or exceed four (4) meters in overall length, trawls 13 in accordance with the present invention are preferably assembled using a “Radial Pattern.” A Radial Pattern trawl 13 progressively reduces the size of mesh cells 30 from front to back of the trawl 13 through progressively shorter mesh bars 72. Thus, within individual mesh cells 30 of a Radial Pattern trawl 13 the two mesh bars 72 nearer the mouth 26 of the trawl 13 are longer than the two mesh bars 72 further from the mouth 26. One characteristic of such a trawl 13 is that despite tapering of the panel 56 the number of mesh cells 30 across a panel 56 remains constant throughout any portion that is assembled using the Radial Pattern. Thus, the portion of a trawl 13 assembled using a Radial Pattern lacks any abrupt change both in mesh bar length, e.g. halving of mesh bar length, or in the number of mesh cells 30 across a panel 56.

For example, in each mesh cell 30 of a Radial Pattern portion of a trawl 13, a ratio of length of mesh bars 72 nearer the mouth 26 of the trawl 13 to length of mesh bars 72 further from the mouth 26 may be 1.25:1 (one and a quarter to one), 1.35:1 (one and thirty-five hundredths to one), 1.1:1 (one and one tenth to one), etc. Preferably the ratio of lengths of mesh bars 72 nearer the mouth 26 of the trawl 13 and those further from the mouth 26 is between 1.15:1 (one and fifteen hundredths to one to one) and 1.2:1 (one and two tenths to one). Ratios exceeding 1.2:1 (one and two tenths to one) up to a 1.4:1 (one point four to one), or larger are less preferred.

To facilitate repair of the trawl 13 if damaged through contact with the ocean bottom 14, the Radial Pattern construction may not be used in the bottom panel 56B, particularly the portion of the bottom panel 56B nearest the footrope 44 at the weights 23 of the trawl 13. This portion of the trawl 13, which is most likely to experience such damage, is preferably assembled using smaller mesh cells 30 having uniform lengths for the mesh bar 72 which facilitates repair.

### Unitary Mesh Bar 72 for Spliced Eyes

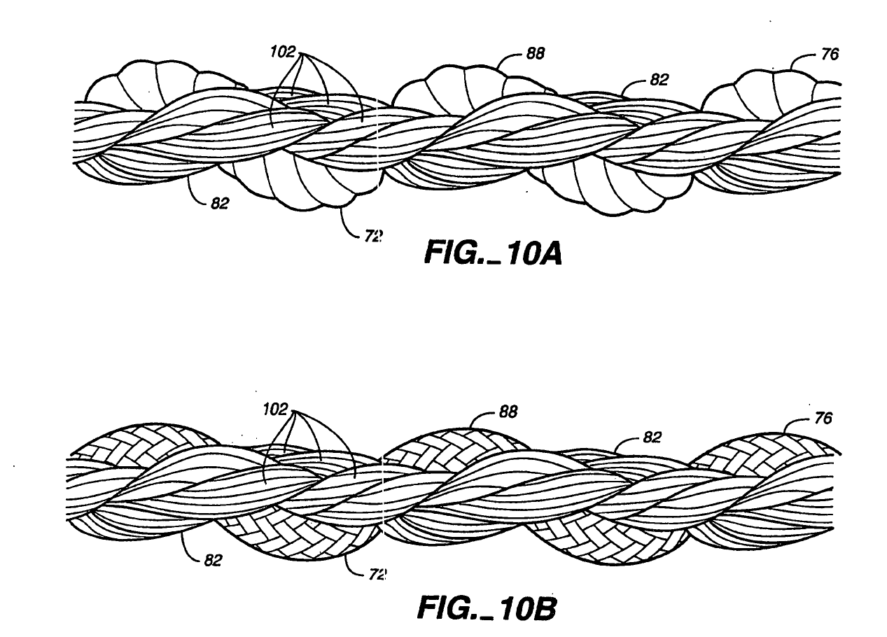

FIGS. 10A and 10B respectively depict product strand constructions that provide rugged, unitary mesh bars 72 the ends of which may be easily formed into spliced eyes. When towed through the body of water 12, the product strand constructions depicted in FIGS. 10A and 10B advantageously exhibit less drag and vibration than a comparably-sized, conventional product strand of either twisted, braided, or over-braided construction.

The constructions depicted in FIGS. 10A and 10B may be considered as either:
i. an adaptation of the mesh bar 72 depicted in FIG. 6 which omits the product strand 77 and uses large diameter product strands 102 with an even larger diameter product strand 76; or
ii. an adaptation of a conventional braided rope in which at least one interwoven plait, i.e. product strand 76, has a significantly larger cross-sectional area than other plaits, i.e. the product strands 102.

In the illustration of FIG. 10A, a dense construction, i.e. firm/hard lay, conventional twisted three-strand rope forms the larger cross-sectional area interwoven plait, i.e. product strand 76. In the illustration of FIG. 10B, a dense construction, i.e. compact twine, braided rope forms the larger cross-sectional area interwoven plait, i.e. product strand 76. The construction depicted in FIG. 10B is preferred because the possibility exists that the twisted three-strand rope depicted in FIG. 10A may become unwound or unlaid during braiding of the mesh bar 72.

The larger cross-sectional area, interwoven plait, i.e. product strand 76, provides the mesh bar 72 with a loose, corkscrew-shaped pitch which establishes deep grooves 82 that are helically-shaped and deeper and broader than the depressions in conventional tightly or loosely twisted three-strand rope or cable. When mesh bars 72 of either type depicted in FIG. 10A or 10B are towed through the body of water 12 oriented obliquely to the water flow vector 86 they exhibits less drag and vibration than a conventional braided twine of equivalent strength. Furthermore, if mesh bars 72 of either type depicted in FIG. 10A or 10B are incorporated into a properly configured trawl 13, cambered sections 88 established by the deep grooves 82 produce outwardly directed lift.

Lacking the product strand 76, the mesh bars 72 depicted respectively in FIGS. 10A and 10B can be manufactured using conventional rope braiding machinery. Use of conventional rope braiding machinery permits easily manufacturing either type of mesh bar 72 depicted in those FIGs. over a greater range of pitch for product strand 76 than permitted by current machinery used in manufacturing the mesh bar 72 depicted in FIG. 6.

In comparison with the mesh bar 72 depicted in FIG. 6, omission of the product strand 77 permits quickly forming spliced eyes at ends of the mesh bars 72 depicted in FIGS. 10A and 10B. Thus, while the mesh bar 72 depicted in FIG. 6 and the mesh bars 72 respectively depicted in FIGS. 10A and 10B exhibit similar ruggedness, the ability to quickly and easily form spliced eyes at ends of the mesh bars 72 depicted in FIGS. 10A and 10B preserves significantly more of the strength of the mesh bars 72, and also reduces drag of the trawl 13 in comparison with a trawl 13 assembled with mesh bars 72 of the type depicted in FIG. 6.

Similar to the product strand 76 depicted in FIG. 6, the product strand 76 included in the mesh bars 72 depicted in FIGS. 10A and 10B should initially be as smooth as practicable, and should wear and/or abrade as smooth as possible. For example, when incurring recurrent abrasive contact, such product strands 76 should not develop a visually observable haired, furry, or fuzzy appearance as commonly occurs for product strands 76 if made from nylon, particularly un-impregnated or un-bonded nylon product strands. Rather, the product strand 76 of such mesh bars 72 should wear smooth, as smooth as possible. Thus, polyethylene and other smooth wearing fibers are preferred for the product strand 76 included in the mesh bars 72 depicted in FIGS. 10A and 10B. The smaller diameter plaits in the mesh bar 72 are preferably made from nylon or polyester product strands 102.

The mesh bar 72 depicted in FIGS. 10A and 10B is preferably braided using six (6) plaits, one of which is the larger diameter product strand 76. A ratio of the cross-sectional area of the product strand 76 to the combined cross-sectional areas of the product strands 102, e.g. five (5), included in the mesh bar 72 should 0.9:1.0 (nine-tenths to one) to 1.0:1.0 (one to one), or greater. Furthermore, instead of including a single product strand 76 in the mesh bars 72 depicted in FIGS. 10A and 10B, two or more product strands may be braided side-by-side in contact with each other to increase the cambered sections 88 of the mesh bar 72. For such a multi-stranded construction, it is advantageous to use differing cross-sectional areas for the several product strands making up such a compound product strand 76. The entire mesh bar 72 depicted in FIGS. 10A and 10B is preferably impregnated with a bonding material.

### Industrial Applicability

In general, as disclosed in published PCT patent application WO 98/46070, mesh bars 72 formed from bonded product strands 76, 77 exhibit significantly greater lift, e.g. a 1.3 to 1.7 or more greater lift, than unbonded product strands of identical diameter. Published PCT patent application WO 98/46070 specifically discloses that a densely laid, heat set and bonded product strand is preferred for reducing drag and increasing lift of mesh bars 72.

Subsequently, it has been discovered that, after being impregnated, loosely laid nylon product strands 76, 77 prove even more advantageous for mesh bars 72. Specifically, it has been discovered that impregnating, including bonding, previously soft product strands, i.e. product strands which have a substantially compressible cross section before applying an impregnation material, until they are no longer easily deformable provides mesh bars 72 which exhibit even more lift and even less drag than those disclosed in the published PCT patent applications. Product strands which are not easily deformable retain 80% of their cross-sectional width to height ratio upon application 6f one kilogram (1 kg) of pressure per square centimeter. Such product strands 76, 77 which are not easily deformable preserve the profile and configuration of the mesh bars 72, as well as that of the cambered sections created by the loose, corkscrew-shape during and after assembly of the trawl 13, particularly when tension is applied to the mesh bars 72.

Preferably, elastic materials, such as nylon including nylon braided product strands that are overbraided by other product strands, have a substantially compressible cross section prior to impregnation. A urethane polymeric material, or material having similar properties is a suitable material for impregnating the product strands. Applying the impregnation material prior to final assembly of the product strand, i.e. prior to final twisting or braiding, for example during stranding or to the core prior to braiding, is preferred for distributing the impregnation material into the interior of the finished product strand. Because lower drag is particularly important in panels 56 of trawls 13 of the present invention, the disclosure of product strands having substantially compressible cross sections prior to impregnation and substantially incompressible cross sections after impregnation is important to obtaining all the advantages of trawls 13 of the present invention.

### Preferred Construction For Product Stands

To further enhance stability, twisted product strands 76, 77 preferably include three (3) primary sub-strands, where each of the sub-strands has a lay direction opposite to the lay direction of the product strands 76, 77. The product strands 76, 77 are preferably made as at least a three (3) stage product strand, and preferably have a soft, readily deformed construction before impregnation (including coating) and/or overbraiding, and a substantially incompressible construction after impregnation and/or overbraiding. Similarly, product strand 77 in the mesh bar construction depicted in FIG. 6 is preferably both an elastic material, as well as of a material having a readily deformed construction before impregnation and/or overbraiding, and a substantially incompressible construction after impregnation and/or overbraiding.

For product strands 76, 77 used in constructing mesh bars 72 illustrated in FIGS. 4A-4C, the lay of the primary sub-strands making up a twisted product strands 76, 77, also known as “pick angle” or “advance”, is preferably as long as possible for meshes disposed in the top panel 56T and/or bottom panel 56B of the trawl 13. The pick angle or advance of such product strands 76, 77 is longer than that of most contemporaneous product strands used for assembling twisted twine conventional trawls, and often likewise in the side-panels 56S, 56P of trawls 13 of the present invention. The use of product strands 76, 77 having such a long pick angle or advance in the panels 56 further reduces drag and enhances lift.

For further drag reductions and useful lift enhancements, twisted product strands 76, 77 preferably have a different construction for at least one of the three (3) primary sub-strands. For example, one of the primary substrands may be more or less (preferably more) impregnated than the others, or may be of a denser construction than the others. Similarly, the sub-strands, or plaits, making up the braids of a mesh bar 72 as shown in FIG. 6 may include at least one plait or substrand that is more or less (preferably more) impregnated than the others, or of a more dense construction than the others.

Such construction for product strands 76, 77 or for the mesh bar 72 depicted in FIG. 6 also provide advantages in other applications in which a fluid flows past the product strand and/or strength member. Such applications include, but are not limited to, product strands used in netting, or mooring lines such as for buoys, ships, oil drilling or refining platforms, attenae, fishing line, paravane line or other seismic line, or other similar applications. All such uses for structures disclosed herein for the mesh bars 72 are intended to be comprehended within the scope of the present invention. Use of structures of mesh bars 72 disclosed herein dramatically reduces oscillations, drag, and fatigue of the product strand and/or strength member, and also dramatically increases the service life of the product strand and/or strength member.

### Reducing Twist in Trawls 13

Because forming mesh bars 72 which provide cambered sections 88 established by the loose, corkscrew-shaped pitch of deep grooves 82 requires twisting pairs of product strands 76, 77 or straps 92, care must be exercised while assembling trawls 13 to eliminate any tendency for their mesh cells 30 to twist-up or wrap-up. Exercising insufficient care in assembling trawls 13 in accordance with the published PCT patent applications produces mesh cells 30 that twist-up or wrap-up. When towed through the body of water 12, self-spreading trawls 13 having mesh cells 30 that twist-up or wrap-up exhibit smaller opening, high drag, collapsing of the back-end 28, undesired bycatch, and/or increased CPUE. Therefore, commercial use of self-spreading trawls 13 that practice any of the inventions disclosed in the published PCT patent applications and in the present application benefits greatly through the use of manufacturing techniques that reduce or eliminate twisting and/or wrapping of mesh cells 30.

To reduce as much as practicable any tendency for twisting and/or wrapping of mesh cells 30, it is important that the filaments making up product strands 76, 77 or straps 92 be pre-shrunk. That is, before being twisted into a product strands 76 or 77 or being woven into a strap 92, the filaments used for manufacturing product strands 76, 77 or straps 92 should possess non-shrink properties, especially as obtained by preshrinking the filaments. A need to pre-shrink filaments before twisting them into product strands 76 or 77 or weaving them into straps 92 is in addition to any subsequent heat setting of the finished product strands 76 or 77 or strap 92 as disclosed in the published PCT patent applications.

Pre-shrinking is particularly advantageous when the product strands 76 or 77 or the strap 92 includes Nylon filaments, or other filaments which exhibit elastic properties similar to nylon filaments. Such materials are preferred for assembling mesh bars 72 such as those depicted in FIGS. 4A-4C, and for the product strand 77 in the mesh bar 72 depicted in FIG. 6. Preferably, after being pre-shrunk, nylon filaments or filaments having elastic properties similar to nylon shrink less than 6% during a stabilization process upon application of heat that is below a temperature and for a time interval that does not degrade or render useless filaments of finished product strands 76 or 77 or strap 92. Particularly for nylon filaments or filaments having elastic properties similar to nylon, particularly for such filaments used to make a product strands 76 or 77, and particularly for twisted product strands 76 or 77, pre-shrinking should reduce subsequent wet shrinkage of the finished product, i.e. a product strands 76 or 77 or a strap 92, to less than 6%, and preferably to less than 1% or 2%.

After construction of the product strands 76 or 77 or strap 92 from pre-shrunk material, e.g. nylon filaments, as disclosed in the published PCT patent applications industry standard stabilization methods, including heat setting, are applied to the product strands 76 or 77 or to the strap 92. After heat setting, the finished product strands 76 or 77, when measured under tension of at least 10 kg [ten kilograms] and after having absorbed the water, shrinkage must not exceed 2%, and preferably does not exceed one 1%.

For the mesh bar construction depicted in FIG. 6, preferably the product strand 77, even if a braided product strand as distinguished from a twisted product strand, exhibits the shrinking characteristics described above to better preserve the original manufactured pitch of the spiraling product strand 76 upon immersion of the mesh bar 72 in water.

If product strands 76, 77 are prepared as described above, and if assembly of the trawl 13 scrupulously avoids imparting torque to mesh bars 72 mesh wrapping due to residual torque may be eliminated, or at least reduced to insignificant levels. For example, torque may be imparted to mesh bars 72 by:
i. rotating prepared product strands 76, 77 along their common axis of symmetry 78 when connecting mesh bars 72;
ii. taking a product strand sideways off a spool; or
iii. otherwise “kinking” twisting a product strand about its longitudinal axis.

Although the present invention has been described in terms of the presently preferred embodiment, it is to be understood that such disclosure is purely illustrative and is not to be interpreted as limiting. Consequently, without departing from the spirit and scope of the invention, various alterations, modifications, and/or alternative applications of the invention will, no doubt, be suggested to those skilled in the art after having read the preceding disclosure. Accordingly, it is intended that the following claims be interpreted as encompassing all alterations, modifications, or alternative applications as fall within-the true spirit and scope of the invention.

1. An improved self-spreading trawl having a mouth that is disposed between a vessel that tows the trawl and a back-end of the trawl that is distal from the towing vessel, the trawl comprising:
a first pair of panels which when the trawl is towed through a body of water become separated with portions of the first pair of panels forming portions of the mouth of the trawl; and
a second pair of panels which when the trawl is towed through a body of water become separated with portions of the second pair of panels forming portions of the mouth of the trawl which differ from the portions of the mouth of the trawl formed by portions of the first pair of panels; and
at least one of the panels of the trawl including at least one mesh cell having at least one mesh bar which includes at least a pair of product strands that form at least one cambered section, the pair of product strands forming the cambered section being selected from a group consisting of:
a. product strands wherein material of one of the product strands is less elastic than material of the other product strand;
b. product strands wherein material of one of the product strands is more hydrophobic than material of the other product strand;
c. product strands wherein at least one of the product strands is smoother than other portions of the cambered section;
d. product strands having differing constructions and one of the product strands is a compact twine;
e. product strands having differing constructions and one of the product strands has an elongate cross-sectional shape; and
f. product strands wherein one of the pair of product strands spirals around the other product strand of the pair and the spiraling product strand is included in a sheath formed by product strands which overbraid the other product strand of the pair, the spiraling product strand having a construction selected from a group consisting of:
i. a width for the spiraling product strand relative to combined widths for the other product strand of the pair and the sheath formed by product strands overbraiding the other product strand of the pair which is at least forty-five hundredths to one (0.45:1);
ii. an elongate cross-sectional shape;
iii. a compact twine;
iv. a surface that is smoother than other portions of the cambered section;
v. material which is more hydrophobic than material of the other product strand of the pair; and
vi. material which is less elastic than material of the other product strand of the pair.

2. The trawl of claim 1 wherein the first pair of panels near the mouth of the trawl is wider than the second pair of panels near the mouth of the trawl.

3. The trawl of claim 1 wherein a distance which separates those portions of the second pair of panels which form portions of the mouth of the trawl is at least 1.14 (one and fourteen-hundredths) times a distance which separates those portions of the first pair of panels which form portions of the mouth of the trawl.

4. The trawl of claim 1 wherein a distance which separates those portions of the second pair of panels which form portions of the mouth of the trawl is at least 1.2 (one and two-tenths) times a distance which separates those portions of the first pair of panels which form portions of the mouth of the trawl.

5. The trawl of claim 1 wherein a distance which separates those portions of the second pair of panels which form portions of the mouth of the trawl is at least 1.5 (one and one-half) times a distance which separates those portions of the first pair of panels which form portions of the mouth of the trawl.

6. The trawl of claim 1 wherein a distance which separates those portions of the second pair of panels which form portions of the mouth of the trawl is at least 2.0 (two) times a distance which separates those portions of the first pair of panels which form portions of the mouth of the trawl.

7. The trawl of claim 1 wherein a distance which separates those portions of the second pair of panels which form portions of the mouth of the trawl is at least 2.5 (two and one-halt) times a distance which separates those portions of the first pair of panels which form portions of the mouth of the trawl.

8. The trawl of claim 1 wherein a distance which separates those portions of the second pair of panels which form portions of the mouth of the trawl is at least 3.0 (three) times a distance which separates those portions of the first pair of panels which form portions of the mouth of the trawl.

9. The trawl of claim 1 wherein a distance which separates those portions of the second pair of panels which form portions of the mouth of the trawl is at least 3.5 (three and one-half) times a distance which separates those portions of the first pair of panels which form portions of the mouth of the trawl.

10. The trawl of claim 1 wherein a distance which separates those portions of the second pair of panels which form portions of the mouth of the trawl is at least 4.0 (four) times a distance which separates those portions of the first pair of panels which form portions of the mouth of the trawl.

11. The trawl of claim 1 wherein a distance which separates those portions of the second pair of panels which form portions of the mouth of the trawl is at least 5.0 (five) times a distance which separates those portions or the first pair of panels which form portions of the mouth of the trawl.

12. The trawl of claim 1 wherein mesh cells near the mouth of the trawl that are juxtaposed with a frontrope are at least 25% (twenty-five percent) open.

13. The trawl of claim 12 wherein mesh cells near the mouth of the trawl that are juxtaposed with a frontrope are at least 30% (thirty percent) open.

14. The trawl of claim 1 wherein mesh cells near the mouth of the trawl that are juxtaposed with a breastline open less than mesh cells near the mouth of the trawl that are juxtaposed with a headrope.

15. The trawl of claim 1 wherein a designed center of a breastline projects at least one (1) full mesh length ahead of a designed center of a headrope.

16. The trawl of claim 1 wherein a designed center of a breastline projects at least three (3) full mesh length ahead of a designed center of a headrope.

17. The trawl of claim 1 wherein mesh bars near the mouth of the trawl that are juxtaposed with a headrope exhibit a drag coefficient which is less than 0.08 (eight hundredths).

18. The trawl of claim 1 wherein mesh bars near the mouth of the trawl that are juxtaposed with a breastline exhibit a drag coefficient which is less than 0.055 (fifty-five thousandths).

19. The trawl of claim 1 wherein mesh bars in the second pair of panels mainly generate more lift per unit area than mesh bars in at least one of the first pair of panels.

20. The trawl of claim 1 wherein mesh bars in the second pair of panels exhibit a lift constant that is mainly greater than a lift constant exhibit by mesh bars in at least one of the first pair of panels.

21. The trawl of claim 1 wherein a cross-sectional area of at least one mesh bars included in the second pair of panels exceeds a cross-sectional area of mesh bars in at least one of the first pair of panels.

22. The trawl of claim 1 wherein a cross-sectional area of at least one mesh bars included in the second pair of panels is no less than 78% (seventy-eight percent) of a cross-sectional area of mesh bars included in the first pair of panels.

23. The trawl of claim 1 wherein a center of a breastline of the trawl is nearer the vessel than a center of a headrope of the trawl.

24. The trawl of claim 1 wherein riblines near the back-end of the trawl exhibit less elongation than mesh bars that are located near the mouth of the trawl.

25. The trawl of claim 1 wherein riblines near the back-end of the trawl exhibit less elongation than riblines that are located near the mouth of the trawl.

26. The trawl of claim 1 wherein mesh bars are made from a material which wears smooth.

27. The trawl of claim 1 wherein mesh bars are made from a material which is more hydrophobic than nylon.

28. The trawl of claim 1 wherein mesh bars are made from a material which is less elastic than nylon.

29. The trawl of claim 1 wherein mesh cells in a region of the second pair of panels that generates more outwardly directed lift than a corresponding region of the first pair of panels are equal in size to mesh cells in the corresponding region of the first pair of panels.

30. The trawl of claim 1 wherein mesh bars in a region of the first pair of panels that generates more outwardly directed lift than a corresponding region of the first pair of panels have a first construction, and mesh bars in the corresponding regions of the second pair of panels have a second construction which differs from the first construction.

31. The trawl of claim 1 wherein mesh cells in a region of the second pair of panels that generates more outwardly directed lift than a corresponding region of the first pair of panels are of a different size from mesh cells in the corresponding region of the first pair of panels.

32. The trawl of claim 1 wherein mesh cells in a region of the second pair of panels that generates more outwardly directed lift than a corresponding region of the first pair of panels are smaller than mesh cells in the corresponding region of the first pair of panels.

33. The trawl of claim 1 wherein individual panels of the second pair of panels are narrower than individual panels of the first pair of panels.

34. The trawl of claim 1 wherein individual panels of the first pair of panels taper more than individual panels of the second pair of panels.

35. The trawl of claim 1 wherein mesh cells generating outwardly directed lift are assembled using a radial pattern in which mesh bars that are nearer the mouth of the trawl are longer than mesh bars of the same mesh cell that are further from the mouth.

36. The trawl of claim 1 wherein, despite tapering of the panel, a number of mesh cells across a panel of the trawl remains constant throughout that portion of the trawl which is assembled using the radial pattern.

37-45. (canceled)

46. A method for assembling an improved self-spreading trawl having a mouth that is disposed between a vessel that tows the trawl and a back-end of the trawl that is distal from the towing vessel, the trawl comprising:
a first pair of panels which when the trawl is towed through a body of water become separated with portions of the first pair of panels forming portions of the mouth of the trawl; and
a second pair of panels which when the trawl is towed through a body of water become separated with portions of the second pair of panels forming portions of the mouth of the trawl which differ from the portions of the mouth of the trawl formed by portions of the first pair of panels;
the method comprising the step of selecting a pair of product strands for forming a cambered section that is included in at least one mesh bar of at least one of the panels of the trawl from a group consisting of:
a. product strands wherein material of one of the product strands is less elastic than material of the other product strand;
b. product strands wherein material of one of the product strands is more hydrophobic than material of the other product strand;
c. product strands wherein at least one of the product strands is smoother than other portions of the cambered section;
d. product strands having differing constructions and one of the product strands is a compact twine;
e. product strands having differing constructions and one of the product strands has an elongate cross-sectional shape; and
f. product strands wherein one of the pair of product strands spirals around the other product strand of the pair and the spiraling product strand is included in a sheath formed by product strands product strands which overbraid the other product strand of the pair, the spiraling product strand having a construction selected from a group consisting of:
i. a width for the spiraling product strand relative to combined widths for the other product strand of the pair and the sheath formed by product strands overbraiding the other product strand of the pair which is at least forty-five hundredths to one (0.45:1);
ii. an elongate cross-sectional shape;
iii. a compact twine;
iv. a surface that is smoother than other portions of the cambered section;
v. material which is more hydrophobic than material of the other product strand of the pair; and
vi. material which is less elastic than material of the other product strand of the pair.

47. The method of claim 46 wherein material selected for forming the mesh bar wears smooth.

48. The method of claim 46 wherein material selected for forming the mesh bar is more hydrophobic than nylon.

49. The method of claim 46 wherein material selected for forming the mesh bar is less elastic than nylon.
